(19) United States
(12) Patent Application Publication
(10) Pub. No.: US 2023/0375030 A1
(43) Pub. Date: Nov. 23, 2023

(54) CLINCHING SLEEVE FASTENER

(71) Applicant: Ewing-Foley, Inc., Cupertino, CA (US)

(72) Inventor: Michael J. Maloney, Doylestown, PA (US)

(73) Assignee: Ewing-Foley, Inc., Cupertino, CA (US)

(21) Appl. No.: 18/230,933

(22) Filed: Aug. 7, 2023

Related U.S. Application Data
(63) Continuation of application No. 18/119,607, filed on Mar. 9, 2023.
(60) Provisional application No. 63/318,562, filed on Mar. 10, 2022.

(51) Int. Cl. F16B 37/04

(52) U.S. Cl. CPC F16B 37/048

(57) ABSTRACT

A clinching sleeve fastener is shown and described. The clinching sleeve fastener includes a first fastener part and a second fastener part. The first fastener part includes a head located at a first end and a shank located at a second end. The head is tapered such that it narrows the further away from the center of the first fastener part. An undercut is located between the first and second end of the first fastener part. The first fastener part further includes knurls located between the head and the undercut. A threaded opening extending through the first fastener part from the first end to the second end. The opening includes a step where the opening is wider on one side of the step. The second fastener part is a collar having a cross section which matches that of the first part. The collar has an opening extending therethrough.

### CROSS REFERENCE TO RELATED APPLICATIONS

This application Claims the benefit of U.S. Non-Provisional application Ser. No. 18/119,607, filed on Mar. 9, 2023 which claims the benefit of U.S. Provisional Application No. 63/318,562 filed on Mar. 10, 2022. The above identified patent application is herein incorporated by reference in its entirety to provide continuity of disclosure.

### BACKGROUND OF THE INVENTION

The present invention relates to fasteners. More particularly, the present invention provides a sleeve clinching fastener which can be used to secure thin sheets of material together.

Technology is constantly improving, new materials are constantly being used to manufacture goods, new requirements are constantly being added to existing technologies and the abilities and capabilities of manufacturing are constantly advancing. Each of these improvements and changes leads further improvements and advancements being required.

Some methods for attaching strong threaded fasteners to very thin panels employ snap in features created in the installation hole in the panel—which takes up valuable area on the panel surface. These features also fail to adequately resist torque. Methods that use welding fail due to the excess heat which will either badly warp the thin panel, or burn through it consistently. Adhesives are not usable with such small fasteners on very thin panels given that there is very little surface area for the adhesive itself, and that excess adhesive will often foul the threads in the fastener. Adhesives also make the fasteners very difficult to position.

Consequently, there is a need for an improvement in the art of fasteners. The present invention substantially diverges in design elements from the known art—while at the same time solves a problem many people face when needing to removably or otherwise secure at least two sheets of a material together. In this regard the present invention substantially fulfills these needs.

### SUMMARY OF THE INVENTION

The present invention provides a clinching sleeve fastener wherein the same can be utilized for providing convenience for the user when fastening materials together. The clinching sleeve fastener includes a first fastener part and a second fastener part. The first fastener part includes a head located at a first end and a shank located at a second end. An undercut is located between the first and second end of the first fastener part. The second fastener part is a collar having a cross section which matches that of the first part. The collar has an opening extending therethrough. The first fastener part is secured within the second fastener part.

Another object of the clinching sleeve fastener is to have the first fastener part include knurls. The knurls are located between the head and the undercut.

Another object of the clinching sleeve fastener is to have the head be tapered, narrowing away from the center of the first fastener part.

Another object of the clinching sleeve fastener is to have the first fastener part have a circular cross section.

Another object of the clinching sleeve fastener is to have the opening of the collar have a circular cross section.

Another object of the clinching sleeve fastener is to have the first fastener part have an opening extending therethrough.

Another object of the clinching sleeve fastener is to have the opening of the first fastener part be threaded.

Another object of the clinching sleeve fastener is to have the opening of the second fastener part include a step. The opening is wider on one side of the step than on the other.

Another object of the clinching sleeve fastener is to have the second fastener part be made of a material that is more malleable than the first fastener part.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a side view of a prior art fastener.

FIG. 1B shows cross sectional view of a prior art fastener secured in a first sheet.

FIG. 2 shows a perspective view of an embodiment of the clinching sleeve fastener.

FIG. 3A shows a perspective view of an embodiment of the collar for the clinching sleeve fastener.

FIG. 3B shows a cross sectional view of an embodiment of the collar for the clinching sleeve fastener.

FIG. 4A shows a cross sectional view of an embodiment of the clinching sleeve fastener prior to securing two plates together.

FIG. 4B shows a cross sectional view of an embodiment of the clinching sleeve fastener after securing two plates together.

FIG. 5A shows a partially exploded view of an embodiment of a second material being secured to at least one plate using a threaded fastener and the clinching sleeve fastener.

FIG. 5B shows a cross sectional view of an embodiment of a second material being secured to at least one plate using a threaded fastener and the clinching sleeve fastener

### DETAILED DESCRIPTION OF THE INVENTION

Reference is made herein to the attached drawings. Like reference numerals are used throughout the drawings to depict like or similar elements of the clinching sleeve fastener. For the purposes of presenting a brief and clear description of the present invention, a preferred embodiment will be discussed as used for the clinching sleeve fastener. The figures are intended for representative purposes only and should not be considered to be limiting in any respect.

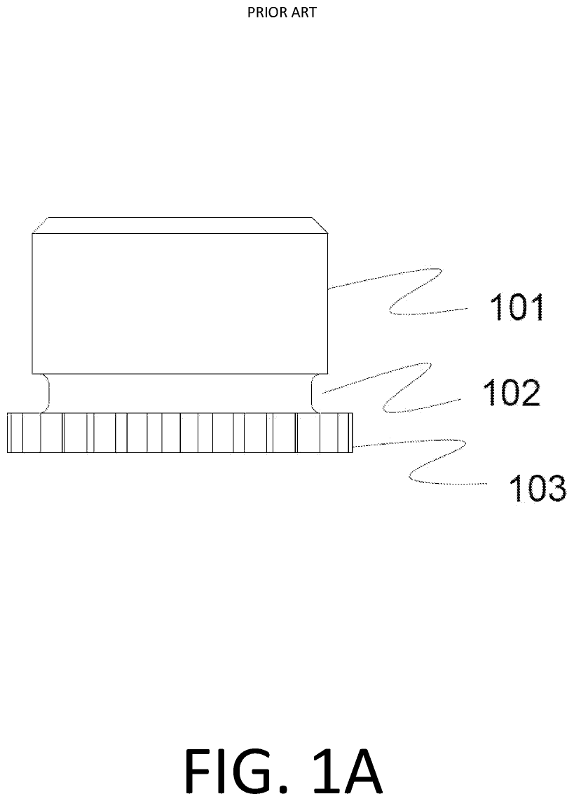

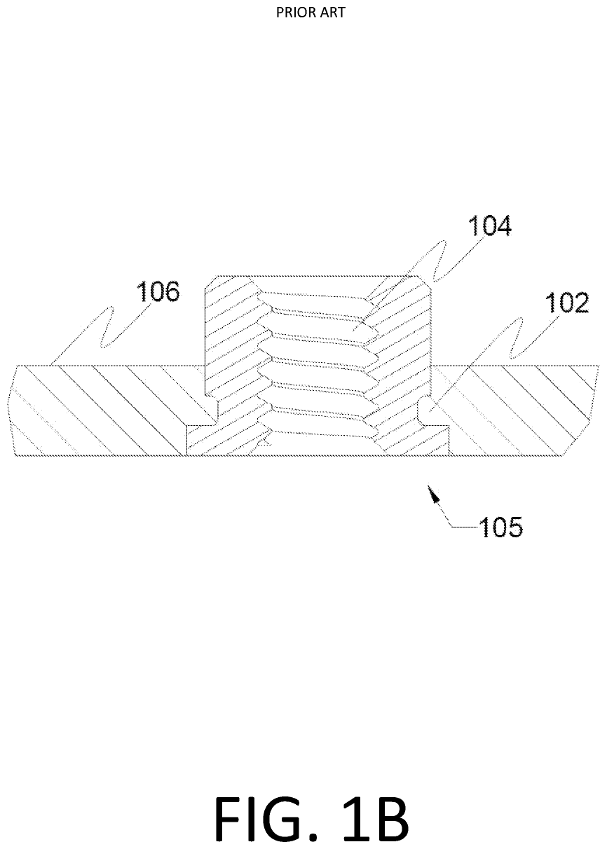

Referring now to FIG. 1A and FIG. 1B, there is shown a side view and a cross sectional view of a prior art fastener. The prior art fastener shown includes several similar features to the current invention. However, these features are in significantly different locations, and thus significantly changes the functions and uses for this fastener. The prior art fastener includes a shank 101 and undercut 102, and a knurled section 103. In some embodiments the fastener may include a threaded interior 104. However, this is where the similarities end.

In many embodiments the shank of the prior art fastener makes up a majority of the fastener. This places the undercut toward the head 105 of the fastener. This requires that the material(s) 106 to be secured together fill the undercut 102. Similarly, the knurls 103 are located about the head 105. This means that the knurls 103 must engage the materials 106 to be pressed together. This creates several drawbacks including the potential to damage materials 106 and for the fasteners to turn or pull out.

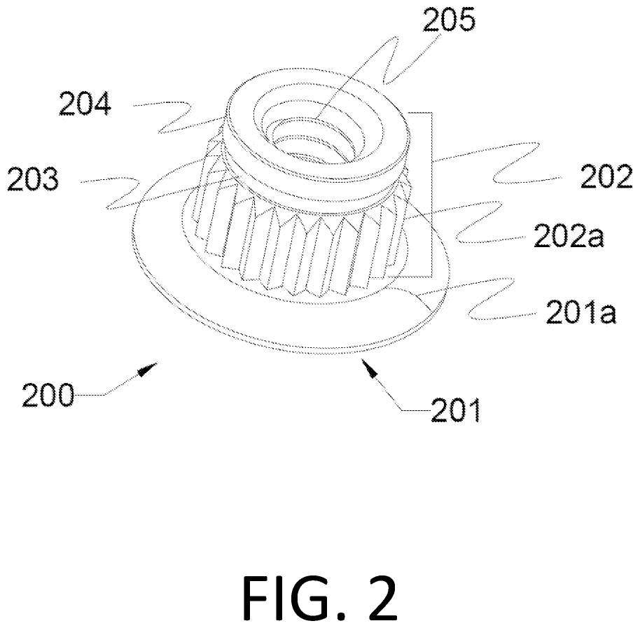

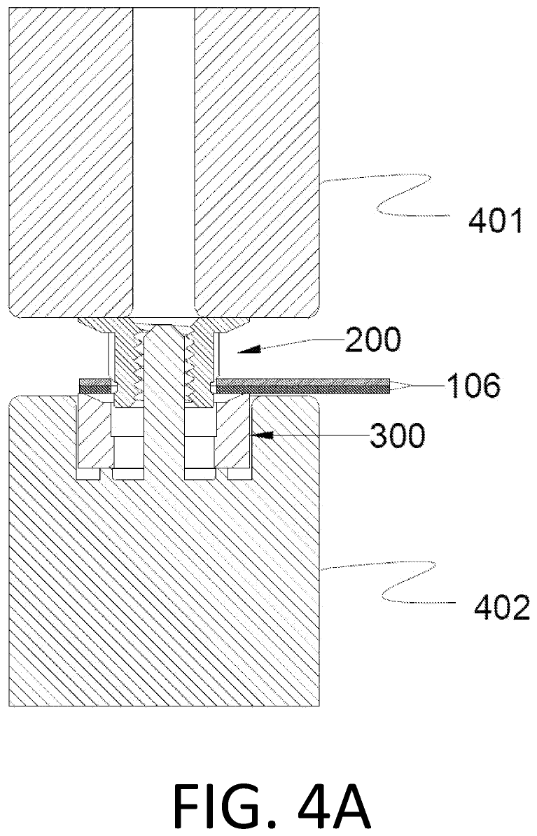

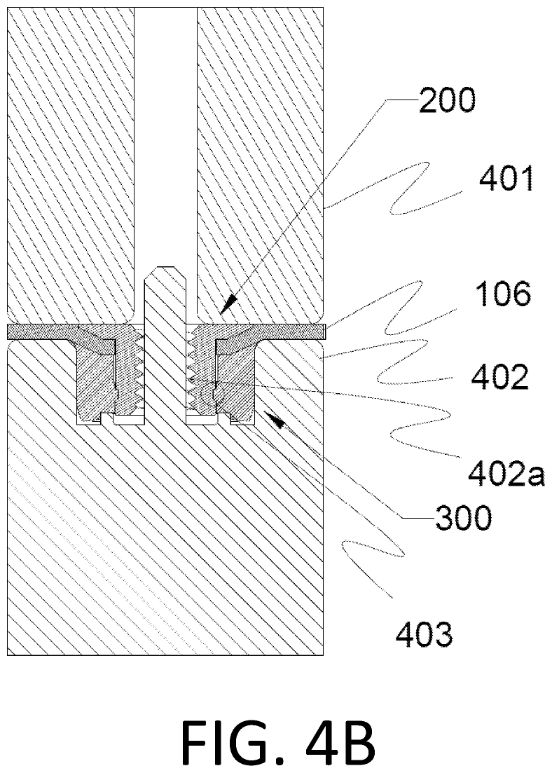

Referring now to FIG. 2, there is shown a perspective view of an embodiment of the clinching sleeve fastener. The clinching sleeve fastener includes a first fastener part 200. The first fastener part 200 has head 201 located at one end. In one embodiment the head 201 includes a taper 201a. In the shown embodiment the taper will narrow as it moves away from the center of the first fastener part 200. The purpose of the taper will be more thoroughly discussed in the description of FIG. 4B.

Below the head 201 is a body section 202. In the shown embodiment the body 202 includes knurls 202a. The knurls 202a prevent the first fastener part 200 from spinning once properly installed. In another embodiment another shape may be used to prevent the first fastener part 200 from spinning. Many non-circular or non-cylindrical shapes will accomplish this goal. However, knurls 202a provides a large surface area and many indents to prevent spinning as described below.

Adjacent to the body 202 and opposite the head 201 is an undercut 203. The undercut 203 is a channel which will allow for metal to be forced therein. This will secure the fastener into place. In the shown embodiment the undercut 203 encircles the entirety of the first fastener part 200. The remaining area of the first fastener part 200 comprises a shank 204. The shank 204 allows for the full creation of the undercut 203. Further, the shank 204 can be used as a guide when securing the fastener.

In one embodiment there is an opening 205 located within the first fastener part 200. The opening travels through the center of the fastener from the head 201 through the shank 204. In one embodiment the opening 205 will allow for reduction in the weight of the fastener. In another embodiment the opening 205 is threaded. This will allow for an additional device or material to be secured using a screw.

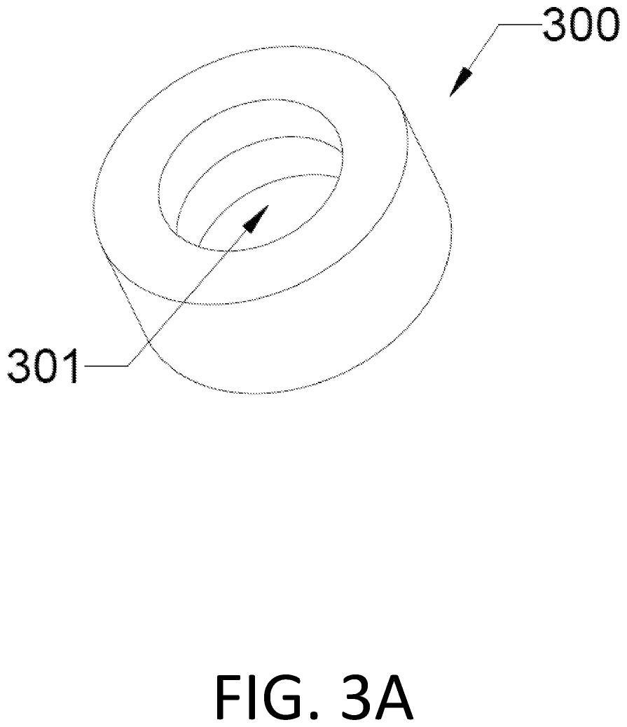

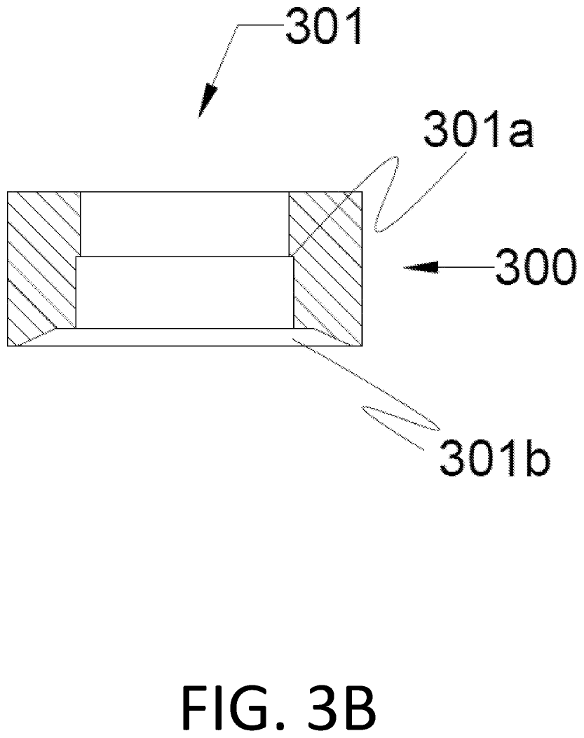

Referring now to FIG. 3A and FIG. 3B, there is shown a perspective view and a cross sectional view of an embodiment of the collar for the clinching sleeve fastener. The clinching sleeve fastener includes a second fastener part 300. In one embodiment the second fastener part 300 is a collar. In another embodiment the second fastener part 300 may be a sheet of material containing an aperture. The collar 300 includes an opening 301 through the center. The opening 301 has a cross section which substantially matches that of the first fastener part 200. In one embodiment the opening 301 includes at least one step 301a. In one embodiment the area of the opening is larger on one side of the step 301a than the other. This will allow for the shank 101 of the first fastener part 200 to catch the step and force the material of the collar into the undercut and the open area of the opening 301a.

In some embodiments the opening further includes a bevel 301b. In one embodiment the bevel 301b matches that of the taper of the head of the first fastener part 200. In another embodiment instead of a bevel 301b there is a second step. The second step will allow for the opening 301 to have an even wider opening. These features will allow for the head of the first fastener part 200 to sit flush with fastened materials 106 as described below.

Referring now to FIG. 4A and FIG. 4B, there is shown two cross sectional views of an embodiment of the clinching sleeve fastener; one is prior securing two plates together and the second is after securing two plates together. In one embodiment there a tool is used to press the first fastener part 200 into the second fastener part 300. The tool includes a press 401. The press 401 will apply pressure to the first fastener part 200. The tool also includes a support 402. The support 402 is able to hold the second fastener part 300 therein. When the press 401 forces the first fastener part 200 into the second fastener part 300 the support 402 will hold the second fastener part steady. In one embodiment the support 402 includes a central prong 402a. The central prong 402a will ensure that the first fastener part 200 and the second fastener part 300 stay aligned.

In the shown embodiment the clinching sleeve fastener is securing together two pieces of material 106. When the clinching sleeve fastener is pressed together and secured several things take place to ensure the materials 106 are properly held together. First, the first fastener part 200 applies force to the second fastener part 300. This force forces the material of the second fastener part 300 to move. As the material 106 is moved, the material of the second fastener part 300 is forced into the undercut of the first fastener part 200, call out 403. Second, the head of the first fastener part 200 is pressed against the materials 106. The materials 106 are forced into the opening of the second fastener part 300. The tapered head of the first fastener part 200 allows for the materials 106 to bend without being sheared off. Further this allows for the first fastener part 200 it sit flush with the surface of the materials.

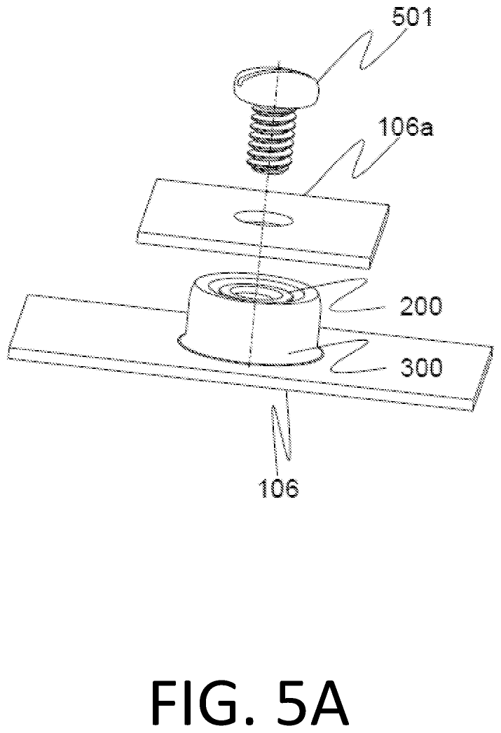

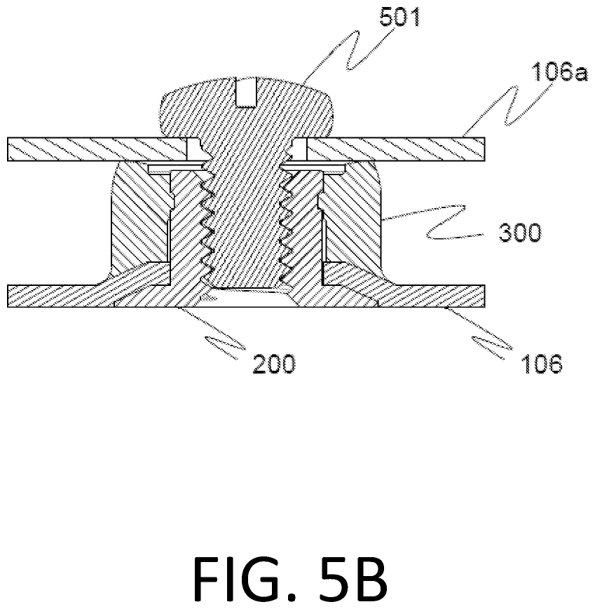

Referring now to FIG. 5A and FIG. 5B, there is shown various views of an embodiment of a second material being secured to at least one plate using a threaded fastener and the clinching sleeve fastener. In the shown embodiment the clinching sleeve fastener 200, 300 is coupled together through a material 106. The threaded interior 205 of the first fastener part 200 is visible. A second material 106a can be fitted to the clinching sleeve fastener 200, 300. A screw 501 can then be used to secure the second material 106a to the clinching sleeve fastener 200, 300.

In this embodiment the clinching sleeve fastener 200, 300 not only is used to secure materials together but also acts as a spacing device. By using the clinching sleeve fastener 200, 300 a space may be created between the first material 106 and the second material 106a. This space may vary in size depending on the thickness of the clinching sleeve fastener 200, 300.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A clinching sleeve fastener, the fastener is comprised of:
A first fastener part and a second fastener part;
The first fastener part is comprised of a head located at a first end and a shank located at a second end;
An undercut is located between the first and second end of the first fastener part.
The second fastener part is a collar having a cross section which matches that of the first part;
The collar has an opening extending therethrough;
Wherein the first fastener part is secured within the second fastener part.

2) The clinching sleeve fastener of claim 1, the first fastener part further comprises knurls; wherein the knurls are located between the head and the undercut.

3) The clinching sleeve fastener of claim 1, wherein the head is tapered, narrowing away from the center of the first fastener part.

4) The clinching sleeve fastener of claim 1, wherein the first fastener part has a circular cross section.

5) The clinching sleeve fastener of claim 1 wherein the opening of the collar has a circular cross section.

6) The clinching sleeve fastener of claim 1, wherein the first fastener part has an opening extending therethrough.

7) The clinching sleeve fastener of claim 6, wherein the opening of the first fastener part is threaded.

8) The clinching sleeve fastener of claim 1, wherein the opening of the second fastener part includes a step; wherein the opening is wider on one side of the step than on the other.

9) The clinching sleeve fastener of claim 1, wherein the second fastener part is made of a material that is more malleable than the first fastener part.
